(19) United States
(12) Patent Application Publication
(10) Pub. No.: US 2009/0156204 A1
(43) Pub. Date: Jun. 18, 2009

(54) APPARATUS AND METHOD FOR AUTOMATIC ROAMING OF TERMINAL IN DIGITAL CABLE BROADCASTING NETWORK

(76) Inventors: Soon Choul KIM, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/335,609

(22) Filed: Dec. 16, 2008

(30) Foreign Application Priority Data
Dec. 17, 2007 (KR) 10-2007-0132003

(51) Int. Cl. H04W 4/00

(52) U.S. Cl. 455/432.1

(57) ABSTRACT

An automatic roaming apparatus and method of a terminal in a digital cable broadcasting network is provided. The method includes: performing device authentication of the terminal when terminal authentication is requested by the terminal; verifying whether roaming authentication of the terminal having requested the terminal authentication is required; requesting subscriber authentication for a Provisioning Server (PS) in a home domain and receiving the subscriber authentication when the terminal exists in the home domain, when the roaming authentication of the terminal is verified as being required; transmitting a result of the device authentication and the subscriber authentication as a response to the terminal; and instructing an Integrated Personalization Server (IPS) to download a Conditional Access (CA) application to the terminal.

### CROSS-REFERENCE TO RELATED APPLICATION

This application claims priority from Korean Patent Application No. 10-2007-0132003, filed on Dec. 17, 2007, in the Korean Intellectual Property Office, the entire disclosure of which is incorporated herein by reference.

### BACKGROUND OF THE INVENTION

1. Field of the Invention

The present invention relates to an automatic roaming apparatus and method of a mobile terminal in a digital cable broadcasting network, and more particularly, to an apparatus and method which enables device authentication and subscriber roaming authentication online without additionally undergoing a new service subscription process.

This work was supported by the IT R&D program of MIC/IITA [2007-S-007-01, The Development of Downloadable Conditional Access System].

2. Description of Related Art

Various Conditional Access Systems (CASs) are currently used based on an embodiment form of Conditional Access (CA) application for CA of digital cable broadcasting, however, a cable card of either a smart card form or a Personal Computer Memory Card International Association (PCMCIA) card form is generally used. Since a predetermined time is required for card reissuance when a CAS defect occurs, by distributing CAS operating software (CAS Client) offline using either the smart card or the PCMCIA card, there is a disadvantage that a quick corrective action is difficult and an additional cost for card reissuance occurs. A Downloadable Conditional Access System (DCAS) being a CAS of a software-based secure downloading scheme has been recently disclosed in order to overcome the disadvantage. For this, related technology development is under way. When the DCAS is introduced, a Multiple System Operator (MSO) providing a cable broadcasting channel service may effectively reduce time and costs required for terminal distribution/maintenance/repair, customer support, and the like. An online software downloading scheme is maximally utilized and many application service technologies that may not be applied to a legacy system may be variously applied. A conventional server configuration and a service scenario for a downloadable CA service are described below.

The DCAS is generally divided into a DCAS headend and a DCAS terminal, and transceives information using a Hybrid Fiber Coax (HFC) network. The DCAS terminal supporting a two-way channel needs to download a CA application to a Secure Micro (SM) being installed in the DCAS terminal for receiving a cable broadcasting service and substituting a legacy cable card function, and needs to drive the CA application. For this, the DCAS terminal securely downloads the encrypted CA application from an Integrated Personalization Server (IPS) after undergoing a mutual authentication process between an Authentication Proxy (AP) of the DCAS headend and the SM. For the above-described consecutive process, the AP uses the SM and a DCAS protocol, and transceives key information related to authentication from a Trusted Authority (TA) for SM authentication.

A fee-based broadcasting service may be used in a digital cable broadcasting service structure after a System Operator (SO) based on an area of a predetermined scale permits a service receiving authority based on a subscription process to a service user. However, since a concept about a subscriber and service roaming similar to a roaming service example of a mobile network does not exist, the fee-based broadcasting service may not be currently used when a cable broadcasting user temporarily moves to another area and intends to use the fee-based broadcasting service without undergoing the service subscription process of the corresponding MSO in an area to which the user moves taking along a set top box being used by the user. When the set top box for cable broadcasting is portable owing to a current trend of miniaturization and integration of a multimedia device, and is available being integrated as a personal multimedia terminal of a Personal Video Recorder (PVR) (a personal storage device) function and the like, the cable broadcasting service needs to be able to be provided in an area in which the roaming contract is concluded between MSOs anytime and anywhere using the terminal of the user.

Accordingly, even when the terminal supporting downloadable CA in the digital cable broadcasting network departs from a service area including the terminal and moves to another service area in which the roaming contract is concluded, an apparatus and method of completing device authentication and subscriber authentication online and normally receiving the cable broadcasting service without undergoing the service subscription process in the corresponding MSO accessing after moving is required.

### SUMMARY OF THE INVENTION

An aspect of the present invention provides an automatic roaming apparatus and method of a mobile terminal in a digital cable broadcasting network.

Another aspect of the present invention also provides an apparatus and method of performing automatic roaming when a terminal of a Downloadable Conditional Access System (DCAS) supporting downloadable Conditional Access (CA) in a digital cable broadcasting network moves to a cable network of another Multiple System Operator (MSO) with whom a roaming contract is concluded.

The present invention is not limited to the above-described purposes and other purposes not described herein will be apparent to those of skill in the art from the following description.

According to an aspect of the present invention, there is provided a method of supporting automatic roaming of a terminal in an Authentication Proxy (AP) server of a DCAS, the method including: performing device authentication of the terminal when terminal authentication is requested by the terminal; verifying whether roaming authentication of the terminal having requested the terminal authentication is required; requesting subscriber authentication for a Provisioning Server (PS) in a home domain and receiving the subscriber authentication when the terminal exists in the home domain, when the roaming authentication of the terminal is verified as being required; transmitting a result of the device authentication and the subscriber authentication as a response to the terminal; and instructing an Integrated Personalization Server (IPS) to download a CA application to the terminal.

According to another aspect of the present invention, there is provided an automatic roaming method of a terminal in a digital cable broadcasting network, the method including: verifying whether device authentication of the terminal is required when receiving a Security Announce message; inspecting user profile information; requesting terminal authentication for an AP server by attaching a user profile; transmitting a terminal authentication request message including the user profile information to the AP server; receiving a terminal authentication result from the AP server; and downloading a CA application from an IPS.

Additional aspects, features, and/or advantages of the invention will be set forth in part in the description which follows and, in part, will be apparent from the description, or may be learned by practice of the invention.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates a network configuration of a Downloadable Conditional Access System (DCAS) being automatically downloadable in a digital cable broadcasting network according to an exemplary embodiment of the present invention;

FIG. 2 illustrates a DCAS of classifying a DCAS operator network and a Multiple System Operator (MSO) network according to an exemplary embodiment of the present invention;

FIG. 3 illustrates a process when a DCAS terminal in a digital cable broadcasting network moves to another MSO network of a DCAS home domain according to an exemplary embodiment of the present invention;

FIG. 4 illustrates a process when a DCAS terminal in a digital cable broadcasting network moves to an MSO network of a DCAS visited domain according to an exemplary embodiment of the present invention;

FIG. 5 is a flowchart illustrating a process during which an Authentication Proxy (AP) of a DCAS performs authentication in order to support automatic roaming according to an exemplary embodiment of the present invention; and

FIG. 6 is a flowchart illustrating a process during which a terminal in a digital cable broadcasting network receives terminal authentication from a DCAS operator network of a DCAS supporting automatic roaming according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures. When detailed descriptions related to a well-known related function or configuration are determined to make the spirits of the present invention ambiguous, the detailed descriptions will be omitted herein.

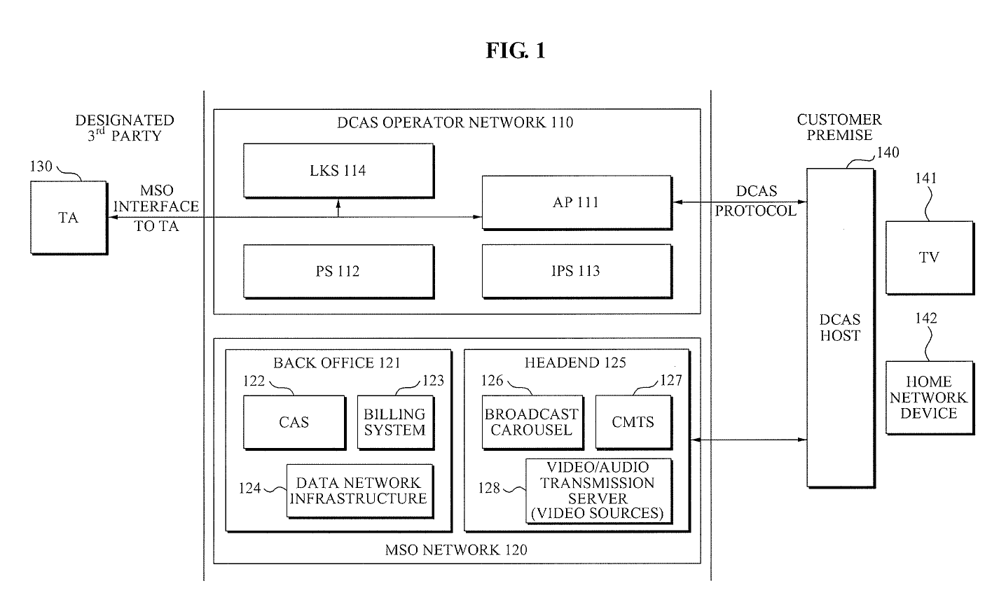

The present invention relates to an automatic roaming apparatus and method when a terminal of a Downloadable Conditional Access System (DCAS) for supporting downloadable Conditional Access (CA) in a digital cable broadcasting network moves to a cable network of another operator with whom a roaming contract is concluded, and a network of the DCAS in which automatic roaming is possible in the digital cable broadcasting network of the present invention is described with reference to FIG. 1.

FIG. 1 illustrates a network configuration of a DCAS being automatically downloadable in a digital cable broadcasting network according to an exemplary embodiment of the present invention.

Before descriptions with reference to FIG. 1, the DCAS is a system being disclosed in order to download a CA application using a Hybrid Fiber Coax (HFC) network, and to enable a Multiple System Operator (MSO) to freely select and flexibly change a Conditional Access System (CAS) appropriate for an environment, and a plurality of CA schemes may be applied without hardware change. The DCAS is defined to interoperate the CAS not substituting or changing the legacy CAS having operated. Therefore, the present invention enables the DCAS to independently exist being separated from an MSO network 120 operated by a legacy CA scheme, and illustrates this (*the DCAS) in a DCAS operator network 110.

Referring to FIG. 1, the DCAS operator network 110 according to an exemplary embodiment of the present invention includes servers such as an Authentication Proxy (AP) server 111, a Provisioning Server (PS) 112, an Integrated Personalization Server (IPS) 113, and a Local Key Server (LKS) 114, and enables a downloadable CA service to be provided. The AP server 111 is a server to directly communicate with a DCAS host 140, and the IPS 113 is a downloading server to download a Secure Micro (SM) client to a terminal, and the PS 112 is a server for provisioning and scheduling for DCAS operation, and the LKS 114 is a server for storing and managing all key values related to system operation.

A back office 121 and a headend 125 of the MSO network 120 include units for CAS service operation and control management, and main units are described below. The back office 121 and the headend 125 include a CAS 122 for CAS service control, a billing system 123 associated with billing and a Subscriber Management Server (SMS), a data network infrastructure 124 for other network services, a broadcast carousel server 126 to transmit broadcasting data, a Cable Modem Termination System (CMTS) 127 to control data transmission, and a video/audio transmission server (video sources) 128 for video/audio transmission.

The servers of the DCAS operator network 110 perform SM authentication in order to securely download the SM client (the CA application) to an SM of the DCAS host 140 using interaction with the DCAS host 140, perform an encryption/decryption function of a message transmitted between the SM and a headend server, and manage key information, various data, and the like requested for the SM authentication. The servers enable an interface with a subscriber management system (including the billing system) for the legacy CA service to be included. A DCAS network protocol is used for supporting secure communication with a DCAS headend system and a subscriber terminal system. The DCAS operator network 110 includes an interface with an external authentication device (a Trusted Authority (TA)) being a third TA for terminal authentication of the DCAS host 140.

The DCAS host provides a television (TV) 141 and a home network device 142 with video/audio data.

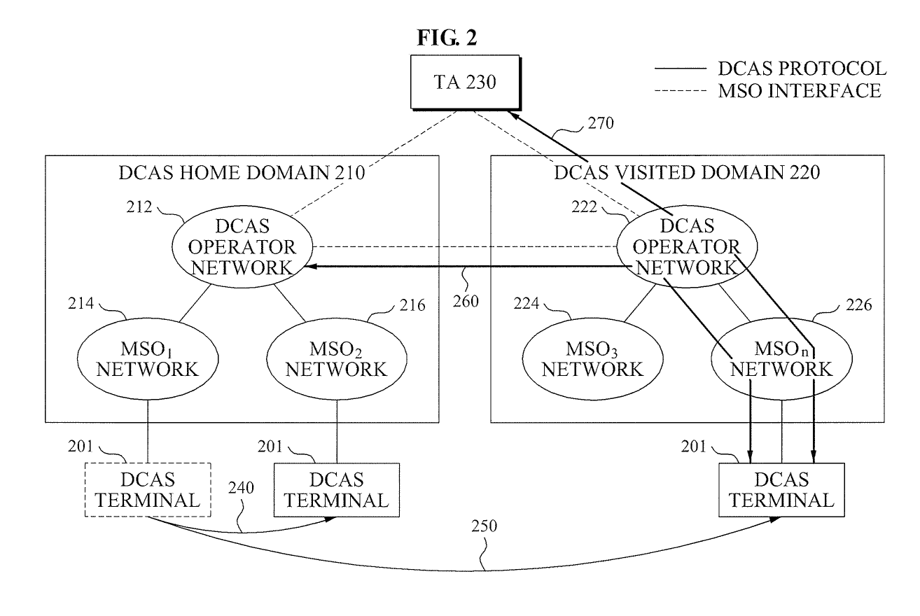

FIG. 2 illustrates a DCAS of classifying a DCAS operator network and an MSO network according to an exemplary embodiment of the present invention. Before descriptions with reference to FIG. 2, device authentication described below is a process for authenticating whether a terminal is a legitimate terminal permitted by a DCAS service provider, and subscriber authentication for service subscription denotes a process for performing authentication with respect to a service use right for a user formally completing user registration in the DCAS service provider.

Referring to FIG. 2, DCAS operator networks 212 and 222 include an interface with at least one MSO networks 214, 216, 224, and 226 and provide a downloadable CA service, and the MSO networks 214, 216, 224, and 226 may entrust and provide a consecutive process with respect to terminal authentication and CA application downloading to the DCAS operator networks 212 and 222 for providing the downloadable CA service. It is included that the MSO directly possesses the DCAS operator network and manages the downloadable CA service with respect to sub operators.

An area in which the DCAS operator networks 212 and 222 operate and manage a device for the downloadable CA service of the several MSO networks 214, 216, 224, and 226 is referred to as a DCAS domain, and a DCAS operator network domain including the MSO network 214 managing service subscriber information of a specific DCAS terminal 201 is referred to as a DCAS home domain with respect to the terminal, and when moving to another DCAS operator network domain and intending to receive a service, this is referred to as a DCAS visited domain 220. The DCAS terminal 201 may move to another MSO network 216 in the DCAS home domain 210 including the DCAS terminal 201 similar to movement in operation 240, or may move to the MSO network 226 including another DCAS domain 220 in operation 250. The DCAS terminal 201 moving to another network may receive a cable broadcasting service from the DCAS operator network 212 based on a result of the device authentication and subscriber roaming service authentication. When the DCAS terminal 201 departing from the DCAS home domain 210 and moving to the MSO network 226 included in the other DCAS domain 220 requests authentication for receiving the cable broadcasting service, the requested DCAS operator network 222 performs a subscriber roaming authentication request for the DCAS operator network 212 of the DCAS home domain 210 in operation 260, and performs the device authentication for a TA 230 in operation 270. Communication with a server between the DCAS operator networks 212 and 222 and the TA 230 follows an MSO interface definition.

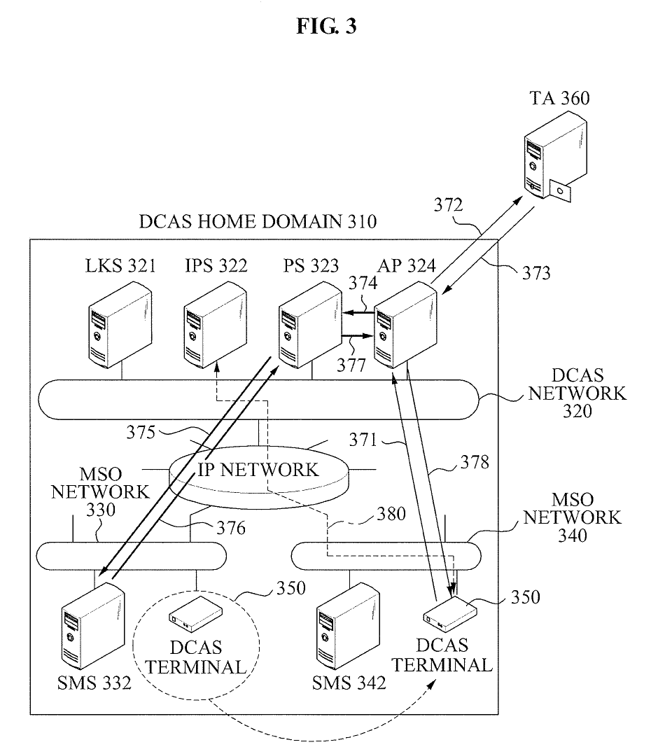

FIG. 3 illustrates a process when a DCAS terminal 350 in a digital cable broadcasting network moves to another MSO network of a DCAS home domain 310 according to an exemplary embodiment of the present invention.

After the DCAS terminal 350 moves to another MSO network 340 in the DCAS home domain 310, an AP 324 may determine whether the AP 324 is included in the DCAS home domain 310 or whether the AP 324 departs from the DCAS home domain 310, with reference to a DCAS domain identifier included in a DCAS protocol message (for example, Security Announce) being periodically broadcasted by the AP 324, and may transmit a request for device authentication and subscriber roaming to the AP 324 by attaching a user profile stored in the DCAS terminal 350 in operation 371. The user profile is a database (DB) storing information about a user subscribing for an initial service, and may include basic information required for subscriber service authentication, identification information of the DCAS home domain 310 and the MSO network 340 for which the user subscribes, token billing information for contents purchasing, and the like. The AP 324 analyzes the user profile of the DCAS terminal 350 requesting the authentication, and determines whether the subscriber roaming authentication in addition to the device authentication is required. The AP 324 performs an authentication function with a TA 360 using operations 372 and 373 based on a predetermined DCAS standard protocol for the device authentication with respect to the DCAS terminal 350, and transmits a subscriber roaming authentication request to a PS 323 in operations 372 and 373 when the subscriber roaming authentication is required. The PS 323 verifies, to an SMS 332 of a corresponding MSO network 330, whether a subscriber based on subscriber information is a valid service subscriber, based on the subscriber information stored in the user profile of the DCAS terminal 350 in operations 375 and 376, and reports a result of the verifying to the AP 324 in operation 377. The AP 324 finally reports a subscriber service authentication result from the PS 323 and a device authentication result with the TA 360 to the DCAS terminal 350 in operation 378, and instructs the IPS 322 to download a CA application in operation 379. When the device authentication and the subscriber roaming authentication are successfully completed, the DCAS terminal 350 may download a new CA application, drive the CA application in an SM, and receive a service in operation 380. An MSO may variously control a roaming service use period using a scheme of setting an expiration time of the CA application and the like.

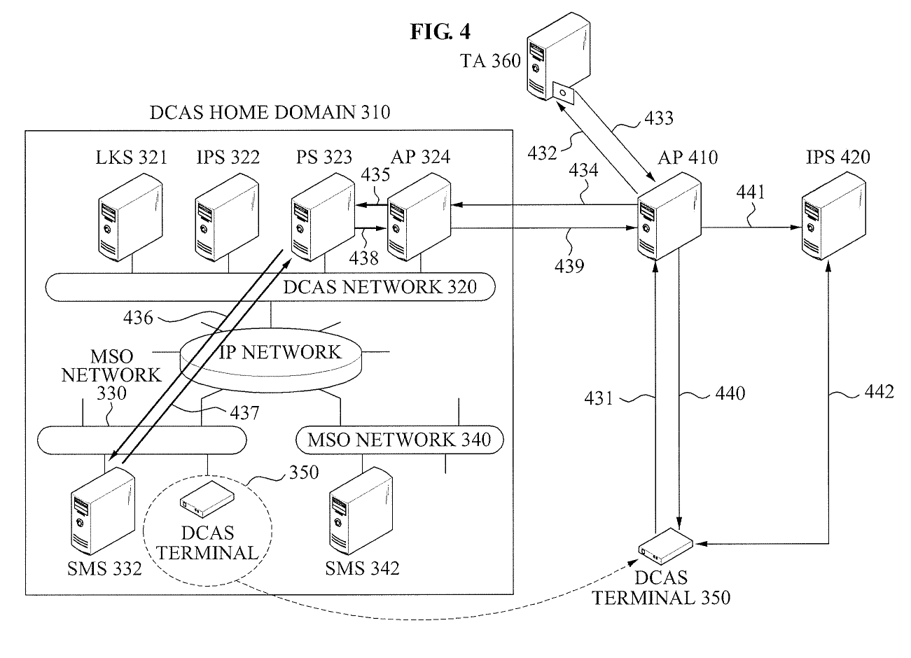

FIG. 4 illustrates a process when a DCAS terminal 350 in a digital cable broadcasting network moves to an MSO network of a DCAS visited domain according to an exemplary embodiment of the present invention.

Referring to FIG. 4, when the DCAS terminal 350 accesses a domain out of a DCAS home domain 310 (the DCAS visited domain), the DCAS terminal 350 moving similar to FIG. 3 attaches a user profile in operation 431 and transmits a request for device authentication and subscriber roaming authentication to an AP 410. The AP 410 of the DCAS visited domain performs the device authentication in operations 432 and 433, verifies home domain identification information of the user profile, and determines whether a subscriber roaming authentication request between domains is required. The AP 410 attempts a subscriber authentication request along with the user profile for an AP 324 included in the home domain 310 of the DCAS terminal 350 in operation 434. The AP 324 transmits a result of the attempting to the AP 410 using a PS 323 and an SMS 332 in operations 435 through 439. The AP 410 finally reports, to the DCAS terminal 350, a subscriber roaming authentication result received from the AP 324 of the home domain 310 and a device authentication result with a TA 360 in operation 440, and instructs an IPS 420 of the DCAS visited domain to download a CA application in operation 411. When the device authentication and the subscriber roaming authentication are successfully completed, the DCAS terminal 350 may download a new CA application, drive the CA application in an SM, and receive a service.

A message transceived between DCAS domains for the subscriber roaming authentication after the DCAS terminal moves to another network is defined in a DIAMETER message code being an Authentication, Authorization, Accounting (AAA) protocol, and information of the user profile basically required for authentication is defined as a DIAMETER Attribute Value Pair (AVP) value, as illustrated in Table 1 and Table 2. Table 1 illustrates a message definition, and Table 2 illustrates a user profile property.

TABLE 1

| Name | DIAMATER Message | (Temporary) |
|---|---|---|
| Authentication | DCAS-Domain-Authentication-Request | 901 |
| request | (DAR) | |
| transmission | | |
| between domains | | |
| Authentication | DCAS-Domain-Authentication-Answer | 902 |
| request response | (DAA) | |
| between domains | | |

TABLE 2

| Name | DIAMETER AVP | Value Type | |
|---|---|---|---|
| Subscriber Information | User Name | String | |
| DCAS Domain Name | Destination Realm | String | |
| MSO Name | Vendor Name | String | |
| Token Accounts for | Token ID* | String | Grouped |
| Contents Purchasing | Token ID* | UnSigned32 | |

However, a message form used for the present invention is not limited to DIAMETER, and an exemplary embodiment of the present invention defined as DIAMETER is described, and a unique message format may be defined and be used for each MSO. Contents included in the defined message include fields defined in the present invention. The user profile may include subscriber information when subscribing for an initial service of the DCAS terminal, a DCAS domain name, and an MSO name, and may attach token accounts for contents purchasing for Impulse Pay Per View (IPPV). The token accounts for contents purchasing enable billing contents remaining after purchasing and using billing contents in a previous DCAS home domain to be used by receiving authentication in a roaming area. The authentication and integrity with respect to user profile contents are added and provided to a payload of a message form between servers or between a server and a terminal.

An example of using messages (DAR and DAA) used between AP servers for performing the subscriber roaming authentication between DCAS domains for a DIAMETER message using the message and the user profile illustrated in the above Table 1 and Table 2 is described below.

| | | |
|---|---|---|
| < DCAS-Domain-Authentication-Request > | :: | <DIAMETER Header> |
| | | <Command-Code AVP = 901> |
| | | <Nonce AVP> |
| | | <User Name AVP> |
| | | <Destination Realm AVP> |
| | | <Vendor Name AVP> |
| | | <Token Accounts AVP>*n |
| < DCAS-Domain-Authentication-Answer > | :: | <DIAMETER Header> |
| | | <Command-Code AVP = 902> |
| | | <Result-Code AVP> |

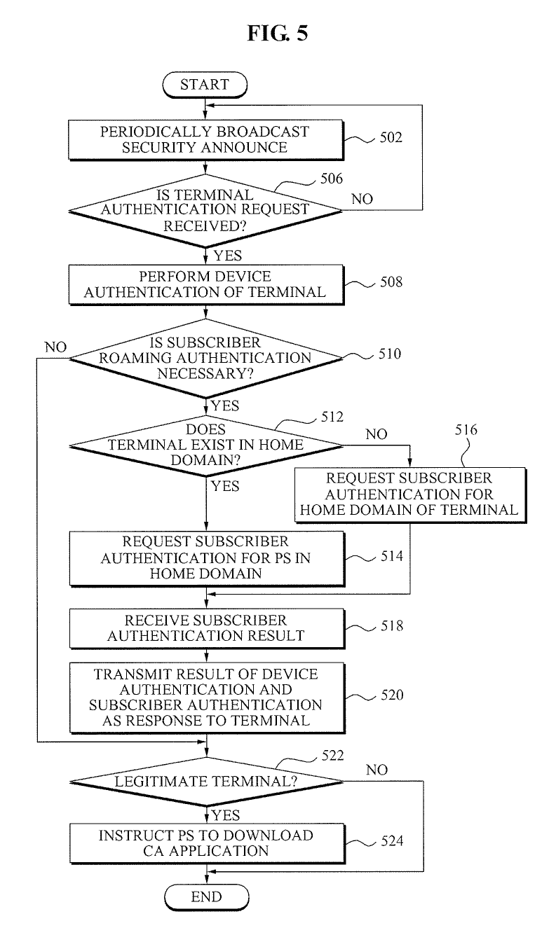

Hereinafter, a method of supporting automatic roaming of a mobile terminal in a DCAS in a digital cable broadcasting network according to an exemplary embodiment of the present invention is described with reference to FIG. 5.

FIG. 5 is a flowchart illustrating a process during which an AP of a DCAS performs authentication in order to support automatic roaming according to an exemplary embodiment of the present invention.

Referring to FIG. 5, the AP according to an exemplary embodiment of the present invention broadcasts a Security Announce message corresponding to a DCAS protocol message being periodically broadcasted in operation 502, receives a terminal authentication request from a terminal in operation 506, performs basic device authentication based on a DCAS network protocol operation using a TA in operation 508, and analyzes a user profile with respect to a subscriber roaming authentication request and verifies whether subscriber roaming authentication is necessary in operation 510. When the subscriber roaming authentication is requested, the user profile is transmitted from the terminal to the AP. When the currently-requesting terminal does not attach the user profile and requests the terminal authentication, it is determined that the subscriber roaming authentication is unnecessary.

When the roaming authentication is verified as being unnecessary in operation 510, the AP proceeds to operation 522. Operation 522 is described below. When the roaming authentication is verified as being necessary in operation 510, the AP verifies whether an identification value of a domain currently including the AP and a domain identification value in the user profile are the same, and whether the terminal exists in a home domain in operation 512. When the values are verified as being the same, that is, when the terminal is included in the home domain, the AP requests subscriber authentication for a PS in the home domain in operation 514. When the domain identification values are verified as being different from each other in operation 512, that is, when the domain including the AP is not the home domain of the terminal, the AP requests the subscriber authentication for the home domain of the terminal in operation 516.

The AP subsequently receives a subscriber authentication result from the AP of the domain or the home domain of the terminal in operation 518, transmits a result of the device authentication and the subscriber authentication as a response to the terminal in operation 520, and verifies whether the terminal corresponds to a licit subscriber terminal in operation 522. When the terminal is verified as the licit subscriber terminal, the AP instructs the PS to download a CA application to the terminal in operation 524. The terminal for which roaming is performed may be controlled by setting temporal limit such as transmitting the CA application for which an expiration period is set.

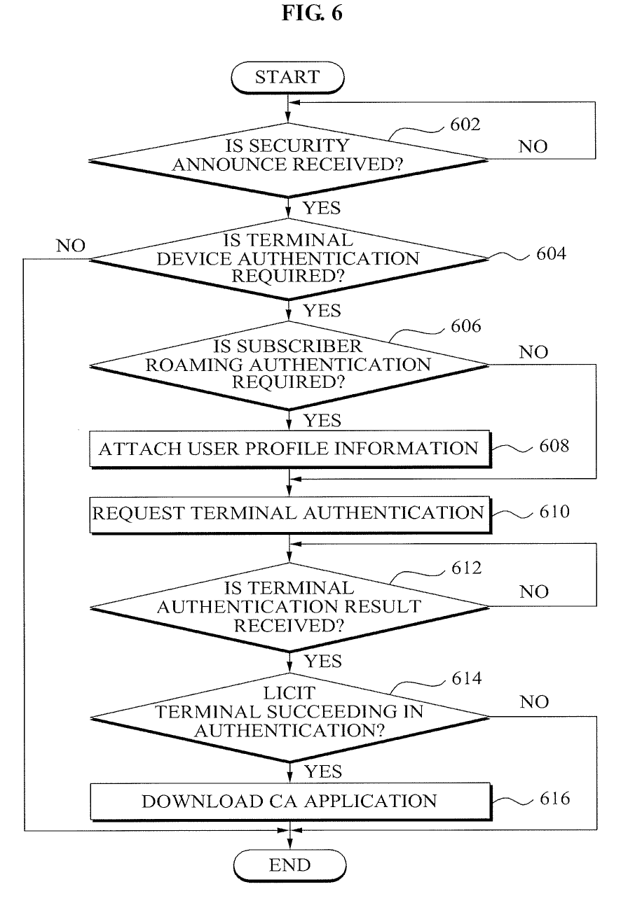

FIG. 6 is a flowchart illustrating a process during which a terminal in a digital cable broadcasting network receives terminal authentication from a DCAS operator network of a DCAS supporting automatic roaming according to an exemplary embodiment of the present invention.

Referring to FIG. 6, when the terminal according to an exemplary embodiment of the present invention receives a Security Announce message corresponding to a DCAS protocol message being periodically broadcasted by an AP in operation 602, the terminal verifies whether a terminal device authentication request is required based on authentication of the terminal and an installation state of a CA application in operation 604. When the terminal device authentication request is verified as being required, the terminal verifies whether roaming starts using a user or terminal environment setting option when a roaming function is supported in operation 606. When subscriber roaming authentication is verified as being requested, the terminal reads user profile information stored in the terminal and attaches the user profile information to protocol information based on a legacy DCAS authentication process in operation 608, and requests terminal authentication for the AP having broadcasted the Security Announce in operation 610. When the subscriber roaming authentication is verified as not being supported or not being requested in operation 606, the terminal does not attach a user profile of operation 608 and proceeds to operation 610.

When the terminal receives a terminal authentication result in operation 612, the terminal verifies whether the terminal corresponds to a licit subscriber terminal succeeding in the authentication in operation 614. When the terminal is verified as the licit subscriber terminal, the terminal downloads and installs the CA application to a PS and subsequently provides a broadcasting service in operation 616.

According to the present invention, there is provided an automatic roaming apparatus and method of a terminal in a digital cable broadcasting network, the method including: performing device authentication of the terminal when terminal authentication is requested by the terminal; verifying whether roaming authentication of the terminal having requested the terminal authentication is required; requesting subscriber authentication for a PS in a home domain and receiving the subscriber authentication when the terminal exists in the home domain, when the roaming authentication of the terminal is verified as being required; transmitting a result of the device authentication and the subscriber authentication as a response to the terminal; and instructing an IPS to download a CA application to the terminal. According to the present invention, it is possible to perform device authentication and subscriber roaming authentication online without additionally undergoing a new service subscription process when a mutual roaming contract is concluded with a corresponding MSO accessing after moving even when a terminal departs from a service area including the terminal and moves to another service area, thereby normally receiving a paid broadcasting channel service in a roaming area.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of supporting automatic roaming of a terminal in an Authentication Proxy (AP) server of a Downloadable Conditional Access System (DCAS), the method comprising:
performing device authentication of the terminal when terminal authentication is requested by the terminal;
verifying whether roaming authentication of the terminal having requested the terminal authentication is required;
requesting subscriber authentication for a Provisioning Server in a home domain and receiving the subscriber authentication when the terminal exists in the home domain, when the roaming authentication of the terminal is verified as being required;
transmitting a result of the device authentication and the subscriber authentication as a response to the terminal; and
instructing an Integrated Personalization Server (IPS) to download a Conditional Access (CA) application to the terminal.

2. The method of claim 1, wherein the verifying verifies whether a user profile is attached when requesting the terminal authentication, and determines that the roaming authentication is required when the user profile is attached.

3. The method of claim 2, wherein the user profile includes at least one of subscriber information, a home domain name, and a Multiple System Operator (MSO) name.

4. The method of claim 2, wherein the user profile includes token accounts for contents purchasing.

5. The method of claim 1, wherein, when the terminal does not exist in the home domain, the requesting and receiving requests the subscriber authentication for the home domain of the terminal, and receives a subscriber authentication result.

6. An automatic roaming method of a terminal in a digital cable broadcasting network, the method comprising:
verifying whether device authentication of the terminal is required when receiving a Security Announce message;
inspecting user profile information;
requesting terminal authentication for an AP server by attaching a user profile;
transmitting a terminal authentication request message including the user profile information to the AP server;
receiving a terminal authentication result from the AP server; and
downloading a CA application from an IPS.

7. The method of claim 6, wherein the user profile includes at least one of subscriber information, a home domain name, and an MSO name.

8. The method of claim 6, wherein the user profile includes token accounts for contents purchasing.
